(19) United States
(12) Patent Application Publication
(10) Pub. No.: US 2015/0258995 A1
(43) Pub. Date: Sep. 17, 2015

(54) Method and Assistance System for Assisting a Driver of a Motor Vehicle as well as Measuring Method and Measuring System for Determining a Mental State of a Driver of a Motor Vehicle

(71) Applicant: TAKATA AG, Aschaffenburg (DE)

(72) Inventors: Stefanie Essers, Berlin (DE); Lisa Diwischek, Berlin (DE)

(73) Assignee: TAKATA AG, Aschaffenburg (DE)

(21) Appl. No.: 14/437,542

(22) PCT Filed: Oct. 22, 2013
(86) PCT No.: PCT/EP2013/072056

§ 371 Date: Apr. 22, 2015

(30) Foreign Application Priority Data
Oct. 22, 2012 (DE) 10 2012 110 059.4

(51) Int. Cl. B60W 40/08

(52) U.S. Cl. CPC B60W 40/08; B60W 2040/0818

(57) ABSTRACT

A method for assisting a driver of a motor vehicle is provided. The method comprises the steps: measuring at least one value of at least one vital parameter of the driver correlated with the mental state of the driver and/or at least one value of at least one driving dynamics variable correlated with the mental state of the driver, classifying the mental state of the driver with reference to the measured value of the vital parameter or the driving dynamics variable, and generating a signal perceptible by the driver by means of a driver assistance system of the motor vehicle, wherein the signal is selected from a plurality of different signals in dependence on the classification of the mental state of the driver, or suppressing a signal of the driver assistance system and/or selecting at least one vehicle parameter in dependence on the classification of the mental state.

The invention relates to a method for assisting a driver of a motor vehicle according to claim 1, a corresponding assistance system according to claim 9, a measuring method for determining a mental state of a driver of a motor vehicle according to claim 10 and a corresponding measuring system according to claim 17.

From the prior art assistance systems for motor vehicles are known, which e.g. control functions of the vehicle and/or warn a driver of the motor vehicle of critical driving situations. A danger involved in the presence of a multitude of assistance systems in a vehicle consists in that the driver too much relies on the assistance systems and/or does not adequately react to information provided by the assistance systems.

The problem to be solved by the invention consists in improving the safety of a motor vehicle.

This problem is solved by the method with the features according to claim 1, the corresponding assistance system with the features of claim 9, the measuring method according to claim 10 and by the corresponding measuring system with the features of claim 17. Developments of the invention are indicated in the dependent claims.

Accordingly, there is provided a method for assisting a driver of a motor vehicle which includes the following steps:
measuring at least one value of at least one vital parameter of the driver correlated with the mental state of the driver and/or at least one value of at least one driving dynamics variable correlated with the mental state of the driver;
classifying the mental state of the driver with reference to the measured value of the vital parameter or the driving dynamics variable; and
generating a signal perceptible by the driver by means of a driver assistance system of the motor vehicle, wherein the signal is selected from a plurality of different signals in dependence on the classification of the mental state of the driver, or suppressing a signal of the driver assistance system and/or selecting at least one vehicle parameter in dependence on the classification of the mental state of the driver.

The method of the invention accordingly provides that a signalization of the vehicle, e.g. a signalization of a driver assistance system, takes account of the mental state of the driver; in particular, an individual mental state is taken into account, which for example is a state of under- or over-challenge, an emotional state (e.g. strong positive or negative excitement) or another state of reduced attention. It is also possible that the mental state is determined by the intention of the driver. Classifying the mental state in particular is effected with reference to individually fixed limit values for the values of the vital parameter and/or the driving dynamics variable (see below).

The signal and/or the vehicle parameter for example is a signal or a parameter of a safety device, a driver assistance system (as mentioned already), a device for influencing the driving dynamics and/or a comfort system of the vehicle.

In dependence on the determined mental state of the driver, for example a signal (such as a signal perceptible by the driver, e.g. an optical, acoustic and/or haptic signal) of an assistance system of the vehicle can be selected, which the driver does not perceive as disturbing or whose information content can be detected by the driver as quickly and correctly as possible. Warnings to the driver thus can be adapted corresponding to his current mental state, wherein e.g. in the case of a driver already determined as stressed the warnings are reduced very much and for example triggered only in the case of high urgency. It is also conceivable that for example in the case of a detected mental state which corresponds to a state of increased stress, i.e. a state of over-challenge, a signalization of the assistance system or another system of the vehicle is suppressed completely.

It is noted that the wording that the signal perceptible by the driver is “selected” in dependence on the classification in particular means that from a plurality of available signals (signalizations) an adequate signalization is selected. For example, the available signals comprise the above-mentioned optical, acoustic and/or haptic signals, wherein the different signals available in particular relate to the same function of the vehicle and thus in particular transport the same information (such as a warning). It is also conceivable that there are each provided several variants of signals of one type, e.g. several optical signals, which include e.g. a first optical signal which addresses the focal visual perception channel of the driver (for example a more static signal), and a second optical signal which addresses the ambient perception channel of the driver (for example a more dynamic signal).

Instead of selecting a signal, a signalization of the vehicle also can be suppressed, i.e. a signalization which would have been effected under standard conditions is inhibited. “Standard conditions” in particular are understood to be a state which corresponds to a vehicle without the classification according to the invention or to a normal mental state of the driver, i.e. in particular that the driver is in an adequately attentive state. In particular, suppressing the signalization includes the fact that the vehicle generates a signal (in particular an electrical signal) which for example indicates that a reaction of the driver is expected (for example an indication of an insufficient tire pressure), but a signalization perceptible by the driver is omitted.

In the case of a detected higher mental stress of the driver, comfort systems likewise might be switched into the background, in order to reduce additional stimuli of the perception of the driver. There can be effected a correspondingly designed feedback to the driver and there can be provided a possibility for again switching on desired systems as simply as possible. In the case of a change of parameters of a comfort system, e.g. the detection of an intention of the driver plays a role. In the classification of the mental state, data (e.g. from a diary) from a vehicle computer can be included, e.g. in order to determine the kind of ride and a possible time pressure of the driver.

In addition, in dependence on the performed classification of the mental state of the driver, e.g. when a state of distinct over-challenge or under-challenge is detected, a vehicle parameter can be changed. For example, the driving dynamics of the vehicle or other variables (for example the maximum speed) of the vehicle can be changed. It is also conceivable that parameters of an (e.g. passive) safety system of the vehicle are changed. For example, the time of activation of a belt tensioner of a safety belt system and/or the triggering of an airbag of the vehicle can be changed (e.g. brought forward). It is also possible that a pre-crash system is triggered at another (in particular earlier) time, wherein e.g. an inflatable element of the pre-crash system is activated and/or the braking pressure is increased at a changed time and/or automatic braking of the vehicle is initiated.

In addition, parameters of an active safety system (such as an ESP system) of the vehicle also can be changed in dependence on the classification of the mental state, e.g. be switched to a higher, more careful attention level. This e.g. also provides for a better avoidance of false alarms, i.e. wrongly triggered warning messages, as it can be detected whether a driving situation has deliberately been caused by the driver or has been produced inadvertently and thus is critical.

It is also conceivable that based on the classification of the mental state of the driver it is detected whether and, if so, to what extent the driver wishes an automation of driving. In some situations, a driver wants to selectively delegate tasks, but in other situations also wants to drive the car himself and enjoy this ride. The determination (the classification) of the mental state of the driver e.g. provides for recognizing better what is desired by the driver, and thus e.g. provides for more fluent transitions between different levels of a driving automation.

The method according to the invention also can promote energy-efficient driving. This becomes possible e.g. by including environmental factors and e.g. a vehicle-to-vehicle communication (“Car-2-X communication”). For example, it can be recognized in how far a green traffic light still can be passed, or rather an early, slow braking—of course by taking account of the traffic flow—should be initiated. Due to the classification of the state of the driver, an improved reaction to other road users also might become possible. It would also be conceivable to recognize which drivers on a specifiable route are stressed and to correspondingly reroute the traffic or show particular consideration for these drivers.

According to one aspect of the invention, for the vital parameters and/or the driving dynamics variable, which are used for classifying the mental state of the driver, a range of values divided into at least one first and one second classification range each is determined, wherein the classification ranges each correspond to different mental states of the driver and the measured value of the vital parameter or the driving dynamics variable are associated to the first or the second classification range. The division of the value ranges in particular is effected individually (related to a particular driver), wherein, as already discussed above, individual class limit values are fixed, which delimit the classification ranges against each other. Fixing the class limit values can be effected by calibration of the measuring device used for determining the vital parameter and/or the driving dynamics variable to a particular driver. For example, the calibration can e.g. be updated regularly.

For example, the mental state associated to the first classification range corresponds to an under-challenge of the driver and the mental state of the driver associated to the second classification range corresponds to an over-challenge of the driver. It is of course also possible that other mental states (see above) are associated to the classification ranges. Of course, more than two classification ranges can also be used, in order to provide for a classification of the mental state as accurately as possible.

According to a development of this aspect of the invention, selecting a signalization (a signal) is effected in that to the first classification range at least one first signal perceptible by the driver is associated and to the second classification range at least one second signal perceptible by the driver is associated (the first signal being different from the second signal), wherein the first signal is generated when the measured value of the vital parameter has been associated to the first classification range, and the second signal is generated when the measured value of the vital parameter has been associated to the second classification range. As already indicated above, the first and the second signal can be different types of signals or variants of the same type of signal, for example an optical signal each, e.g. a first signal which addresses the focal visual perception channel of the driver or a second signal which addresses the ambient perception channel of the driver.

The value of the vital parameter is determined e.g. by determining the electrodermal activity, by means of an electrocardiogram, an eye movement measurement and/or a pupillometric measurement. The driving dynamics variable detected for example is an acceleration of the vehicle which is determined e.g. by means of sensors of an ESP system of the vehicle. Furthermore, e.g. a standard deviation from the lateral position, a number of steering movements, a mean difference between an allowed and the real speed and/or a steering angle can be used as driving dynamics variables.

The invention also relates to an assistance system for assisting a driver of a motor vehicle, in particular for carrying out a method as described above, comprising
a measuring device for measuring at least one value of at least one vital parameter of the driver correlated with the mental state of the driver and/or at least one value of at least one driving dynamics variable correlated with the mental state of the driver;
a classification device for classifying the mental state of the driver with reference to the measured value of the vital parameter or the driving dynamics variable; and
a device for selecting a signal perceptible by the driver or suppressing a signalization of the vehicle and/or selecting at least one vehicle parameter in dependence on the classification of the mental state of the driver.

According to a further aspect, the invention relates to a measuring method for determining a mental state of a driver of a motor vehicle, comprising the steps:
a) generating a first signal perceptible by the driver, which signals to the driver that a first action is expected of him;
b) generating a second signal perceptible by the driver, which signals to the driver that a second specified action is expected of him, wherein the first signal is different from the second signal and/or the expected first action is different from the expected second action; and
c) measuring at least one value of at least one vital parameter of the driver correlated with the mental state of the driver and/or at least one value of at least one driving dynamics variable correlated with the mental state of the driver, while the first signal is generated and/or the first action is performed by the driver and while the second signal is generated and/or the second action is performed by the driver.

The measuring method in particular can serve to determine the mental stress exerted on a driver due to signalizations of the vehicle (in particular of a driver assistance system). It is conceivable to carry out the above-described assistance method according to the invention on the basis of these measurements, wherein for example to different mental states of a driver adequate driver assistance system signals (or signals of another vehicle system) each are associated, one of which is selected in dependence on the classification of the mental state of the driver performed with the assistance method according to the invention.

Should the measurements carried out by means of the measuring method according to the invention reveal for example that an optical signal which chiefly addresses the focal visual perception channel of the driver generates a lower stress of the driver than other signals (e.g. than a visually perceptible signal which addresses the ambient perception channel of the driver) such optical signal might be associated to a state of mental over-challenge, in order to produce an additional mental stress of the driver as low as possible.

The measuring method in particular is carried out by means of a driving simulator which is able to generate different signals as they are e.g. typically generated by driver assistance systems. For example, the first and/or the second signal of the measuring method is a signal perceptible by the driver visually, auditorily, tactilely and/or olfactorily. It should be noted that the first and the second signal very well can consist of a speech information which is communicated to a test person; e.g. a task communicated to the person for example acoustically (e.g. by loudspeaker) or visually (for example by indication on a display).

In addition, the steps a) to c) can be carried out repeatedly, with the type of the first signal and/or the type of the second signal being different each time. The repetitions serve to determine the mental stress from a plurality of combinations of the signals. For example, the steps a) to c) are carried out at least twice, wherein at the first time a visually perceptible signal is used as first and/or second signal and at the second time an acoustic signal is used. It is also conceivable that at the first time a signal of a first type is used as first and/or second signal and at the second time a visually perceptible signal of a second type is used. According to a development of this variant, the visually perceptible signal of the first type is a signal which addresses the focal visual perception channel of the driver, and the visually perceptible signal of the second type is a signal which addresses the ambient perception channel of the driver. It is of course also conceivable for example that different acoustic signals are used. Possible signals and possible types of actions to be expected are listed below in Table 1.

The value of the at least one vital parameter is determined e.g. by determining the electrodermal activity, by means of an electrocardiogram, an eye movement measurement and/or a pupillometric measurement. The used vital parameters of the driver correspondingly are e.g. the following:
an electrodermal activity (EDA);
variables determined by means of an electrocardiogram (ECG) such as non-specific fluctuations, a tonic level, the heart rate, the heart rate variability (0.1-component), wherein a reference EDA and ECG (non-specific fluctuations, tonic level, heart rate, heart rate variability (0.1-component)) also can be determined;
by means of an eye movement measurement certain variables such as viewing direction, fixation number on certain areas of interest (AOI), fixation duration on AOI, fixation spot, number of saccades, duration of saccades, blink frequency;
by means of pupillometry certain variables such as the amplitude of the changes in phasic pupil dilations (e.g. between 0.1-0.6 mm), index of cognitive activity (ICA).

Some of the above-mentioned vital parameters can be determined by means of a measuring device which is integrated into a steering wheel of a vehicle. For example, the measuring device comprises at least one electrode which is arranged on a steering wheel rim of the steering wheel.

The at least one driving dynamics variable correlated with the mental state of the driver for example is a standard deviation from the lateral position, the number of the steering movements, the mean difference between an allowed and the real speed and/or the steering angle. When carrying out the method according to the invention by means of a driving simulator, these variables are obtained from the driving simulator data.

Since a number of different influencing parameters (covariables) can influence the result of the measuring method, the same for example likewise are collected and checked. For example, the following covariables of the test drivers (test persons) are examined: sex, age, driving experience, possibly simulator experience, last hand washing, last sports activity, consumption of drugs and caffeine, current mental state (e.g. tired or rested), time of day, temperature, noise, type of roadway, road condition, season, air moisture, wind, type of vehicle and/or traffic density.

Carrying out the measuring method for example is effected as follows: EDA & ECG measurement probes are applied to the test person. To identify so-called “non-responders” (about 5% of the population), i.e. persons in which no EDA signals can be detected, the test persons are asked to take a deep breath and to hold their breath. In this way, a base level of EDA and ECG likewise is generated and measured.

Subsequently, e.g. two questionnaires are completed (e.g. according to NASA Task Load Index—NASA-TLX and/or SAM—Self-Assessment Manikin), in order to detect the basic stress and the general excitement level of the test person. Then, for example a demographic questionnaire is presented to the test person, in particular in order to collect the above-mentioned covariables sex, age, driving experience, simulator experience, last hand washing, last sports activity, consumption of drugs and caffeine, and the current mental state. In the meantime, the investigator completes a test protocol sheet concerning time of day, temperature, noise, type of roadway, road condition, season, air moisture, wind and type of vehicle. The traffic density and possibly occurring noise disturbances are recorded during the test.

Thereupon, an eye movement measuring apparatus and a pupillometry apparatus are calibrated. Thereafter, the test person for example is given the opportunity to test drive in the driving simulator or in the real vehicle. After some practice time, a base level of the driving performance and the respective driving dynamics variables is detected. When actually carrying out a measurement, different tasks, i.e. actions expected of the driver (of the test person) take effect depending on the objective of the measurement. The tasks in particular are designed to check different input and output modalities of the perception of the test person.

Furthermore, a distinction can be made between checking a pure reaction power (e.g. the requirement to say “Yes” when a stimulus in the form of the first signal is presented) and the different levels of a cognitively stressing task (e.g. easy, medium and difficult). Tasks which are not directly relevant for the driving task (i.e. the “first action”) are referred to as secondary tasks (“second action”). Secondary tasks serve to demonstrate the strain of the driver in the driving data due to his driving performance by different degrees of stress (i.e. in particular by configurations of the “second signal”).

For example, there can be used the first and second signals or first and second actions listed in the following Table 1, which for detecting a mental stress in particular can be combined with each other:

| | Type of the | | |
|---|---|---|---|
| | signal perceptible | | |
| No. | by the driver | Processing | Type of action expected |
| 1 | first signal: visual | reaction | expected first action: verbal |
| 2 | first signal: visual | reaction | expected first action: |
| | | | motoric |
| 3 | second signal: visual | cognitive | expected second action: |
| | | | verbal |
| 4 | second signal: visual | cognitive | expected second action: |
| | | | motoric |
| 5 | first signal: acoustic | reaction | expected first action: verbal |
| 6 | first signal: acoustic | reaction | expected first action: |
| | | | motoric |
| 7 | second signal: acoustic | cognitive | expected second action: |
| | | | verbal |
| 8 | second signal: | cognitive | expected second action: |
| | acoustic | | motoric |
| 9 | first signal: | reaction | expected first action: |
| | visual-acoustic | | verbal |
| 10 | first signal: | reaction | expected first action: |
| | visual-acoustic | | motoric |
| 11 | second signal: | cognitive | expected second action: |
| | visual-acoustic | | verbal |
| 12 | second signal: | cognitive | expected second action: |
| | visual-acoustic | | motoric |

In the case of No. 1 the test person is presented a visual stimulus as first perceptible signal (e.g. a flashing LED) to which the test person is meant to react verbally (e.g. with “Yes”) (“expected first action”). In the second case, the test person likewise is presented a visual stimulus as first perceptible signal (e.g. likewise a flashing LED), to which the person must react motorically (e.g. by pressing a key). In the third case, the test person is given a cognitive task, namely by means of a visual second signal (e.g. an indication on a display) which the person must accomplish verbally (“expected second action”), e.g. by directional instructions.

In the fourth case, the test person e.g. likewise is given a cognitive task on a display, which the person can process motorically by operation using keys or directly on a touch display. In the fifth case, the test person must react verbally (e.g. with “Yes”) to a first signal in the form of an acoustic stimulus (via loudspeaker), in the sixth case motorically by pressing a key. In the seventh case, a task is presented to the test person by means of a second signal in the form of an acoustic signal (likewise via loudspeaker), which the person must process by verbally answering (for example the solution of the task should be spoken).

In the eighth case, a task in turn is presented to the test person acoustically (via loudspeaker) by means of a second signal in the form of an acoustic signal, the solution of which task the person should enter via a display by means of keys or a touch surface (“expected second action”). In the ninth case, a stimulus (“first signal”) is presented visually and acoustically at the same time (e.g. an indication appears on a display and at the same time an instruction is given by loudspeaker), wherein the test person should verbally react to this first signal (e.g. with “Yes”).

In the tenth case, a first signal likewise is presented visually and acoustically (e.g. an indication again appears on a display and in addition an instruction is given by loudspeaker), wherein the test person should motorically react thereto (e.g. by pressing a key). In the eleventh case, a task is presented by a second signal in the form of a both visual and acoustic signal (e.g. by the above-mentioned combination of an indication on a display and an instruction by loudspeaker), wherein the expected second action consists in that the test person must say the solution of the task aloud. In the twelfth case, a task likewise is presented visually and acoustically at the same time, wherein the test person must motorically enter the solution of the task as expected second action via keys or directly on a touch-sensitive display (touch display). As mentioned, the variants listed in the Table can be combined with each other. In particular, the first signals and first actions contained therein can be combined with the second signals and second actions mentioned in the Table. The second signals in particular are generated temporally after the first signals.

The acoustic first and/or second signals can be designed e.g. in the form of the following acoustically or visually communicated tasks (Table 2):

| Type of the first | Type of the | |
|---|---|---|
| and/or second signal | expected | Type of the task communicated by |
| perceptible by | first and/or | means of the first and/or second |
| the driver | second action | signal |
| acoustic or visual | verbal | stimuli/reaction time |
| acoustic or visual | motoric | reaction (stimuli/reaction time) |
| acoustic or visual | verbal | cognitive (“N-back”) |
| acoustic or Visual | motoric | cognitive (“N-back with |
| | | interface interaction”) |
| acoustic-visual | verbal | cognitive (“N-back”) |
| acoustic-visual | motoric | cognitive (“N-back with |
| | | interface interaction”) |

The kind of task communicated by means of the first and/or second signal either consists in a task merely requiring a reaction of the test person or in a mentally demanding task (cognitive). The “N-back” task is a specific demanding task which has an easy, medium and difficult level. At the easy level, a test person must repeat a number which has been presented to the person in the acoustic modality (Example: presentation=3, test person answers “3”), at the medium level the test person must say the number which has been presented before the last number (Example: Presentation=3-5-2-1, test person answers “-”, “3”, “5”, “2”), hence this involves a memory effort, and at the difficult level the test person must say the number which has been presented before the last number but one (Example: Presentation=3-5-2-1, test person answers “-”, “-”, “3”, “5”).

“N-Back with interface interaction” means that the test person does not answer verbally, but selects the number by input device (e.g. switch or touchscreen) and therewith outputs the same manually via an interface (to a machine). Therefore, this output modality corresponds to “motoric” in Table 1.

The tasks are communicated to the test person either acoustically (in particular by loudspeaker announcement), visually (in particular by indication on a display) or acoustically-visually (in particular both by loudspeaker and by an indication on a display).

The tasks communicated by the first and/or second signal e.g. are practiced sufficiently with the test person, until they are understood and mastered completely, in order to exclude learning effects or misunderstandings. The objective in particular is to classify the exact individual patterns with different demands of the driver. Individual patterns are understood to be the expressions of the demands in the physiological data (EDA, ECG, eye movement, pupillometry), which depending on the individual are subject to great fluctuations. The objective is to recognize the ability to drive with reference to these patterns and to make a correspondingly appropriate adaptation of the vehicle (assistance systems and comfort functions), as described above with respect to the first aspect of the invention. Therefore, the measuring method according to the invention might also be implemented in a production vehicle.

At the end of testing (i.e. after completion of the measuring method according to the invention, in particular after completion of several runs of the measuring method according to the invention) the maximum possible span of the EDA signal also can be tested. This can be carried out for example by the so-called “shock-pattern method”, wherein e.g. an involuntary reaction of the test person is caused by a loud bang (e.g. by the investigator beating on the table). There must of course be chosen a method which is damage-free and harmless for the test person. At the end of the measuring method, the test person e.g. again completes the questionnaries NASA-TLX and SAM.

The invention also relates to a measuring system for determining a mental state of a driver of a motor vehicle, comprising
a generating device for generating a first signal perceptible by the driver, which signals to the driver that a first action is expected of him, and for generating a second signal perceptible by the driver, which signals to the driver that a second specified action is expected of him, wherein the first signal is different from the second signal and/or the expected first action is different from the expected second action; and
a measuring device for measuring at least one value of at least one vital parameter of the driver correlated with the mental state of the driver and/or at least one value of at least one driving dynamics variable correlated with the mental state of the driver, while the first signal is generated and/or the first action is performed by the driver and while the second signal is generated and/or the second action is performed by the driver.

The measuring system according to the invention in particular is part of a driving simulator or cooperates with a driving simulator. It is, however, also conceivable that the measuring system is arranged in a vehicle (e.g. also in a production vehicle). In both cases, the measuring device of the measuring system can be integrated into a steering wheel. It is conceivable for example that electrodes and/or other sensors are integrated into the steering wheel for carrying out an EDA and/or ECG measurement.

The invention will subsequently be explained in detail by means of exemplary embodiments with reference to the Figures, in which:

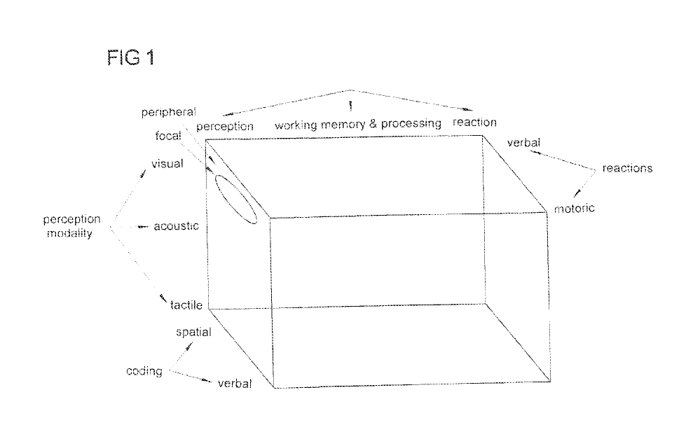

FIG. 1 shows the Wickens cube; and

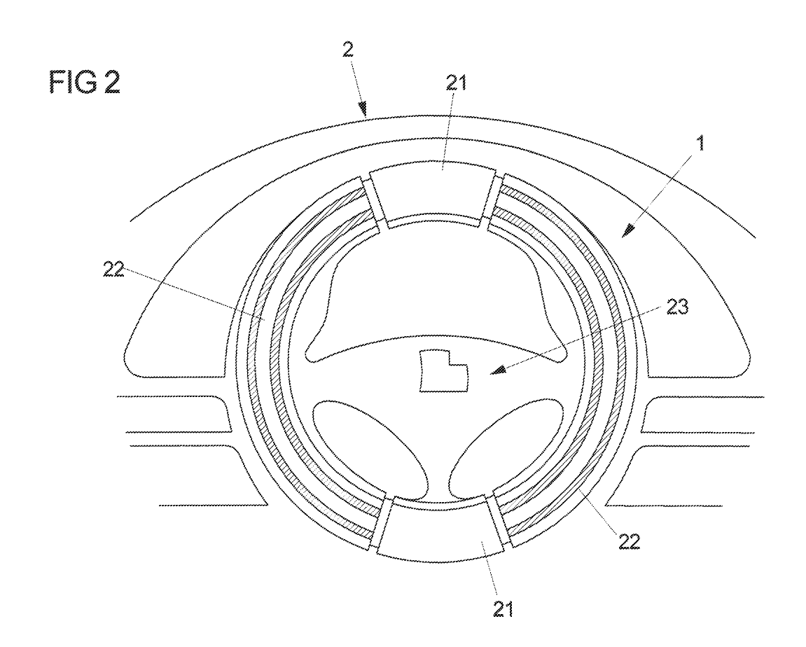

FIG. 2 shows a steering wheel for carrying out the measuring method according to the invention.

A known model of the human intake and processing of information and the reaction to an information is the so-called Wickens cube shown in FIG. 1. The Wickens model represented with this cube brings different aspects (modalities, involved sensory channels, codes and levels) of information processing in connection with each other. The aspects (resources) in particular each are regarded as dichotomous.

In principle, human behavior is divided into the phases “perception”, “storage and processing” (cognitive work) and the production of a response reaction. The forms of perception (“perception modalities”) are divided into visual, auditory or tactile information, wherein it is assumed that these different modalities are processed differently. Within the visual modality there are also two visual sensory channels, namely a focal and an ambient channel. The main task of the focal channel is the object recognition, while the ambient channel is responsible for the perception of movement and the orientation. The different “codes” on the one hand relate to the spatial, analogous storage of information and on the other hand the verbal, symbolic or pictorial storage. “Levels” are understood to be different processing resource levels.

By means of the measuring method according to the invention it is possible to distinguish between the pure take-up of stimuli (based on a “first signal” presented to the driver) and the cognitive processing (based on a “second signal” presented to the driver) when determining a mental state of a driver of a motor vehicle. In addition, when examining the effect of the received information on the mental state of the driver, a distinction can be made between information which is received in different modalities (in particular visual, auditory or tactile). The knowledge obtained by means of the measuring method according to the invention in particular can be used to adapt the signalization of a vehicle (for example of a driver assistance system) (e.g. driver-individually), as explained above.

FIG. 2 shows a steering wheel 1 which comprises a measuring device 2 which is part of a measuring system according to the invention (not shown) for carrying out the measuring method explained above. The remaining parts of the measuring system might be integrated into a vehicle together with the steering wheel 1. In particular, the steering wheel as part of the assistance system according to the invention also might be incorporated into a production vehicle.

The measuring device 2 is formed to determine various vital parameters (“psychophysiological parameters”) which correlate with the mental state of a driver. In particular, the measuring device includes electrodes 21, 22 which each serve as ECG and/or EDA electrode. The electrodes 21, 22 are e.g. dry electrodes. The electrodes 21, 22 together extend over almost the entire outer circumference of the steering wheel rim, in order to ensure that the driver is in contact with at least one of the electrodes. Furthermore, the electrodes 21, 22 have a large surface area; e.g. they also extend (e.g. at least approximately completely) around a skeleton of the steering wheel rim, i.e. they extend over a large part of the circumference of the steering wheel skeleton, which lies in a plane oriented vertically to the outer circumference The electrodes 21, 22 have a particularly large surface area in particular at the usual gripping points of a steering wheel.

The current mental state of the driver will be reflected in (in particular driver-specific) EDA and/or ECG values which on the one hand can be utilized to determine the effects of various stimuli on his mental state in connection with the measuring method according to the invention or to classify the mental state of the driver in a production vehicle and with reference to the classification adapt a signalization of the vehicle, as explained above.

The measuring device integrated into the steering wheel 1 also includes an evaluation unit 23 which detects and evaluates the electrical signals picked up by the electrodes 21, 22. For example, the evaluation unit 23 detects a heart rate of the driver. The source of the human heartbeat is an electric pulse which is generated by a cluster of cells within the heart. Since this pulse is transmitted via the blood stream, it can be demonstrated as potential difference between two points on the body. The electrodes 21, 22 of the steering wheel 1 are formed such that the cardiac activity of the driver can be detected as potential difference between both hands of the driver. For this purpose, the electrodes 21, 22 each consist of two segments and the evaluation unit 23 includes a difference amplifier, in order to be able to register very small potential differences, and a processing unit for filtering out disturbing signals.

The electrodes 21, 22 also serve as temperature sensors with which the skin temperature can be determined as further vital parameter. The body temperature (and hence the skin temperature) is regarded as an indicator for the mental state of the driver and is controlled by the central nervous system as thermoregulation. The normal skin temperature of the hand varies in the range between 20° C. and 40° C. By control of the central nervous system, the body temperature can be regulated by the sweating process. The activity of the sweat glands thus provides a feedback via the sympathetic nervous system and is a feature to assess the state of the driver.

Eccrine sweat glands are widespread throughout the body, above all on hands, feet and forehead. Their density on the hand is more than 2000/cm². Eccrine sweat consists of water and salts, with which the glands either are filled or not. Therefore, the activity of the sweat glands can electrically be measured as a change in conductivity of the skin. In general, the change in conductivity of the human skin lies in the range between 0 μS and 50 μS or equivalently the resistance of the human skin lies between 20 kΩ and infinity. Correspondingly, the electrodes 21, 22 can be formed for measuring the conductivity of the skin of the driver.

The conductivity measurement in particular is effected on the basis of the voltage divider principle, in which two contacts on the skin are required. One pole is set e.g. to a DC voltage of 0.5 V, and the other pole serves the potential measurement which is dependent on the gland activity. The resistance value of the voltage divider resistor is set to e.g. 180 kΩ. This means in particular that a voltage is applied to the resistor, which varies between 0 V and 0.25 V. This signal is amplified e.g. eightfold, and in particular a low-pass filter with a limit frequency of e.g. 10 Hz is superimposed for filtering out the EDA signal.

It should be noted that a DC voltage of 0.5 V is not dangerous to humans. The maximum admissible voltage is 0.7 V, in order to prevent nerve cell excitation. Cells cannot be damaged either by heating or burning, as the maximum input current intensity is e.g. 0.5V×0.5V×50 μS=12.5 μA.

The temperature range for the operation of the steering wheel and the electrodes 21, 22 lies e.g. between −40° C. and +85° C. The storage of the steering wheel is possible e.g. at temperatures between −40° C. and +125° C., wherein in this temperature range a relative air humidity between 5 and 95% is to be expected.

1. A method for assisting a driver of a motor vehicle, comprising the following steps:
measuring at least one value of at least one vital parameter of the driver correlated with the mental state of the driver and/or at least one value of at least one driving dynamics variable correlated with the mental state of the driver;
classifying the mental state of the driver with reference to the measured value of the vital parameter or the driving dynamics variable; and
generating a signal perceptible by the driver by means of a driver assistance system of the motor vehicle, wherein the signal is selected from a plurality of different signals in dependence on the classification of the mental state of the driver, or suppressing a signal of the driver assistance system and/or selecting at least one vehicle parameter in dependence on the classification of the mental state of the driver, wherein
for the vital parameter and/or the driving dynamics variable an expected range of values divided into at least one first and one second classification range each is determined, wherein the classification ranges each correspond to different mental states of the driver and the measured value of the vital parameter or the driving dynamics variable are associated to the first or the second classification range.

2. The method according to claim 1, wherein the signal and/or the vehicle parameter is a signal or a parameter of a safety device, a driver assistance system, a device for influencing the driving dynamics and/or a comfort system of the vehicle.

3. (canceled)

4. The method according to claim 1, wherein the expected range of values is divided into more than two classification ranges.

5. The method according to claim 1, wherein the mental state associated to the first classification range corresponds to an under-challenge of the driver and the mental state of the driver associated to the second classification range corresponds to an over-challenge of the driver.

6. The method according to claim 1, wherein the motor vehicle generates a signal which signalizes that an action of the driver is expected, wherein this signal is selected from a plurality of signals provided by the motor vehicle in dependence on the classification of the mental state of the driver.

7. The method according to claim 6, wherein the signal of the vehicle is generated by a driver assistance system and/or a comfort system of the vehicle.

8. The method according to claim 1, wherein
to the first classification range at least one first signal perceptible by the driver and to the second classification range at least one second signal perceptible by the driver is associated, wherein the first signal is different from the second signal,
and wherein the first signal is generated when the measured value of the vital parameter has been associated to the first classification range, and the second signal is generated when the measured value of the vital parameter has been associated to the second classification range.

9. An assistance system for assisting a driver of a motor vehicle, comprising
a measuring device for measuring at least one value of at least one vital parameter of the driver correlated with the mental state of the driver and/or at least one value of at least one driving dynamics variable correlated with the mental state of the driver;
a classification device for classifying the mental state of the driver with reference to the measured value of the vital parameter or the driving dynamics variable; and
a device for selecting a signal perceptible by the driver or suppressing a signalization of the vehicle and/or selecting at least one vehicle parameter in dependence on the classification of the mental state of the driver, wherein
for the vital parameter and/or the driving dynamics variable an expected range of values divided into at least one first and one second classification range each is determined, wherein the classification ranges each correspond to different mental states of the driver and the measured value of the vital parameter or the driving dynamics variable are associated to the first or the second classification range.

10. A measuring method for determining a mental state of a driver of a motor vehicle, comprising the following steps:
a) generating a first signal perceptible by the driver, which signals to the driver that a first action is expected of him;
b) generating a second signal perceptible by the driver, which signals to the driver that a second specified action is expected of him, wherein the first signal is different from the second signal and/or the expected first action is different from the expected second action; and
c) measuring at least one value of at least one vital parameter of the driver correlated with the mental state of the driver and/or at least one value of at least one driving dynamics variable correlated with the mental state of the driver, while the first signal is generated and/or the first action is performed by the driver and while the second signal is generated and/or the second action is performed by the driver.

11. The measuring method according to claim 10, wherein the first and/or the second signal is a signal perceptible by the driver visually, auditorily, tactilely and/or olfactorily.

12. The measuring method according to claim 10, wherein the steps a) to c) are carried out repeatedly, wherein each time various first and/or second signals are used.

13. The measuring method according to claim 12, wherein the steps a) to c) are carried out at least twice, wherein at the first time a visually perceptible signal of a first type is used as first and/or second signal and at the second time a visually perceptible signal of a second type is used.

14. The measuring method according to claim 13, wherein the visually perceptible signal of the first type is a signal which addresses the focal visual perception channel of the driver, and the visually perceptible signal of the second type is a signal which addresses the ambient perception channel of the driver.

15. The measuring method according to claim 10, wherein the value of the vital parameter is determined by determining the electro-dermal activity, by means of an electrocardiogram, an eye movement measurement and/or a pupillometric measurement.

16. The measuring method according to claim 10, wherein for the at least one vital parameter an expected range of values divided into at least one first and one second classification range each is determined, wherein the classification ranges each correspond to different mental states of the driver and the measured value of the vital parameter or the driving dynamics variable are associated to the first or the second classification range.

17. A measuring system for determining a mental state of a driver of a motor vehicle, comprising
a generating device for generating a first signal perceptible by the driver, which signals to the driver that a first action is expected of him, and for generating a second signal perceptible by the driver, which signals to the driver that a second specified action is expected of him, wherein the first signal is different from the second signal and/or the expected first action is different from the expected second action; and
a measuring device for measuring at least one value of at least one vital parameter of the driver correlated with the mental state of the driver and/or at least one value of at least one driving dynamics variable correlated with the mental state of the driver, while the first signal is generated and/or the first action is performed by the driver and while the second signal is generated and/or the second action is performed by the driver.

18. The measuring system according to claim 17, wherein the measuring device is integrated into a steering wheel of a motor vehicle.
